(19) United States
(12) Patent Application Publication
(10) Pub. No.: US 2026/0359391 A1
(43) Pub. Date: Nov. 12, 2026

(54) METHOD AND SYSTEM FOR AUTOMATED MANY-TO-MANY STATISTICAL ANALYSIS OF MIXED-TYPE VARIABLES

(71) Applicant: Josh Shapiro, Smyrna, GA (US)

(72) Inventor: Josh Shapiro, Smyrna, GA (US)

(21) Appl. No.: 19/696,654

(22) Filed: Jun. 3, 2026

Related U.S. Application Data
(63) Continuation-in-part of application No. 19/203,418, filed on May 9, 2025, now abandoned.

(51) Int. Cl. G06F 17/18; G06F 40/186

(52) U.S. Cl. CPC G06F 17/18; G06F 40/186

(57) ABSTRACT

A system and method for automated many-to-many statistical analysis of a mixed-type dataset is disclosed. The system automatically detects variable types, continuous numerical, discrete numerical, nominal categorical, ordinal categorical, binary, or ranked, and selects the appropriate statistical technique for each variable pair from a predefined deterministic rule set, without human intervention, machine learning, or generative artificial intelligence. For each pair where a statistically significant relationship is found, the system generates a plain-language observation by selecting a pre-authored template for the technique applied and populating it with the variable names and result values—a deterministic, reproducible process. Each observation encodes whether a relationship is significant, its magnitude, and its nature in technique-specific language. The system operates autonomously without user input or in a user-seeded mode where the user designates seed variables. Output is delivered to any consuming system—a user interface, database, API, messaging system, or downstream process or AI agent.

### CROSS-REFERENCE DATA

This application is a continuation-in-part of U.S. patent application Ser. No. 19/203,418, filed May 9, 2025, which is a continuation of U.S. patent application Ser. No. 18/234,301, filed Aug. 15, 2023, which claims priority to U.S. Provisional Patent Application No. 63/399,765, filed Aug. 22, 2022. The disclosures of all prior applications are incorporated herein by reference in their respective entireties.

### BACKGROUND

### Technical Field

The present disclosure relates to automated data analysis, and more particularly to a system and method for performing automated many-to-many statistical correlation analysis across a dataset containing variables of mixed types, wherein the system automatically selects the appropriate statistical technique for each variable pair according to a predefined deterministic rule set without human intervention and without the use of machine learning or generative artificial intelligence, and generates a structured, prioritized set of technique-specific plain-language observations describing statistically significant relationships found, for delivery to any configured consuming system.

### Description of the Related Art

Statistical analysis of multi-variable datasets requires an analyst to identify which pairs of variables to examine, determine the appropriate statistical technique for each pair based on the variable types involved, execute the selected technique, interpret the numerical output, and translate that output into a meaningful plain-language conclusion. Each of these steps has traditionally required human judgment, and specifically the expertise of a trained statistician.

Existing software tools address portions of this workflow but leave critical gaps. Statistical analysis software, such as the SAS Enterprise Guide illustrated in FIGS. 2A and 2B, requires the user to navigate task menus to select an analysis option, such as the “Characterize Data” function shown in FIG. 2A, and to configure the output types manually, as shown in FIG. 2B. Such tools require the user to select and configure the statistical technique to be applied and limit automated analysis to one technique at a time, requiring the user to possess sufficient statistical knowledge to make the selection correctly. Q Software's Smart Tables generate ranked correlation reports but operate only on variable pairs specified by the user and rank results by p-value alone, without accounting for effect size or relationship magnitude; additionally, they produce only one-to-many analysis.

More recent tools have introduced greater automation, but each addresses only a portion of the end-to-end problem. Displayr automates statistical test selection for individual user-specified analyses, selecting the most appropriate test based on the data types and variable set type; however, it requires the user to specify what to test and does not enumerate all variable pairs in a dataset and analyze them simultaneously in a single automated pass. EasyMedStat automatically selects statistical tests and generates plain-language text output, including separate text versions for results and methods sections; however, it is predicated on user-specified analyses rather than system-initiated proactive exploration of all variable pairs. STATSOMAT offers pairwise correlation and association analysis with plain-language interpretation but handles only continuous variables and does not support a unified analytical framework for datasets containing mixed variable types.

No existing commercial tool performs fully automated, many-to-many correlation analysis across a dataset containing variables of mixed types—simultaneously determining the correct statistical technique for each variable pair in the dataset, executing that technique, and generating a structured, technique-specific plain-language observation for each statistically significant result—without human intervention in the technique-selection step and without reliance on a language model or generative artificial intelligence system for any part of the output generation. There is therefore a need for a system and method that addresses all of these limitations in a single, unified, automated pipeline.

### SUMMARY

The present technology provides a system and method for automating many-to-many statistical analysis of a dataset containing variables of mixed types. Given a dataset of any size containing variables of any combination of supported types, the system automatically enumerates every variable pair, determines the correct statistical technique for each pair according to a predefined deterministic rule set that codifies established statistical practice, executes the selected technique for every pair, and translates each statistically significant result into a plain-language observation using a predefined, deterministic template library. No language model, generative artificial intelligence system, or probabilistic text generation method is used at any stage. The output is fully deterministic and reproducible: given the same dataset, the same inputs always produce the same observation text.

Each plain-language observation generated by the system encodes three distinct pieces of information: (i) whether a statistically significant relationship exists between the variables in the pair, as determined by the p-value produced by the technique; (ii) the magnitude or strength of that relationship, as measured by the effect size or correlation coefficient produced by the technique; and (iii) the nature of the relationship, expressed in natural language specific to the statistical technique applied.

The system operates in two modes. In a first, autonomous mode, the system operates on a dataset without any user input, scanning all variable pairs and delivering structured output proactively to any configured consuming system. In a second, user-seeded mode, a user provides one or more seed variables of interest; the system performs the analysis across those seed variables and may optionally and automatically expand the variable set by identifying additional variables that are statistically related to the seed variables, before performing the full analysis across the expanded set. In both modes, the system delivers structured output to any configured consuming system, including but not limited to a user interface, a database, an application programming interface, a messaging or notification system, or an automated downstream process or artificial intelligence agent.

In an aspect, a processor-implemented method of automated statistical analysis of a dataset is provided, comprising: receiving a dataset comprising a plurality of variables; automatically detecting the variable type of each variable; automatically selecting a statistical technique for each variable pair according to a predefined deterministic rule set without human intervention and without the use of machine learning or generative artificial intelligence; executing the selected technique for each pair; generating a plain-language observation for each pair where a statistically significant relationship is found, by selecting a natural language template from a predefined template library and populating that template with variable names and result values, without using a language model or generative artificial intelligence; and delivering a structured prioritized output to at least one consuming system.

In another aspect, a system is provided comprising a processor and memory storing executable modules including a variable detection module, a technique selection module, an execution module, an observation generation module, and an output module, collectively implementing the method described above.

In yet another aspect, a non-transitory computer-readable medium storing instructions for implementing the method described above is provided.

### BRIEF DESCRIPTION OF THE DRAWINGS

FIG. 1 is a block diagram of a system 100 for automated many-to-many statistical analysis of a dataset, showing the processor 103, memory 101, and executable modules including the data module 104, selection module 106, reconciled file content module 107, correlation module 108, analysis module 110, and weight assignment module 112.

FIG. 2A illustrates a statistical analysis software user interface, showing example task and analysis option navigation including the selection of a characterize data function, provided as an illustrative scenario.

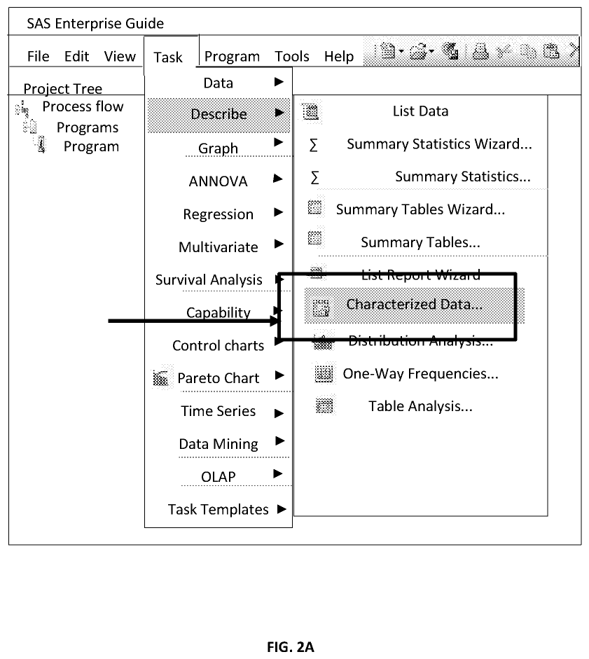

FIG. 2B illustrates a data characterization report options panel showing selectable output types, provided as an illustrative scenario.

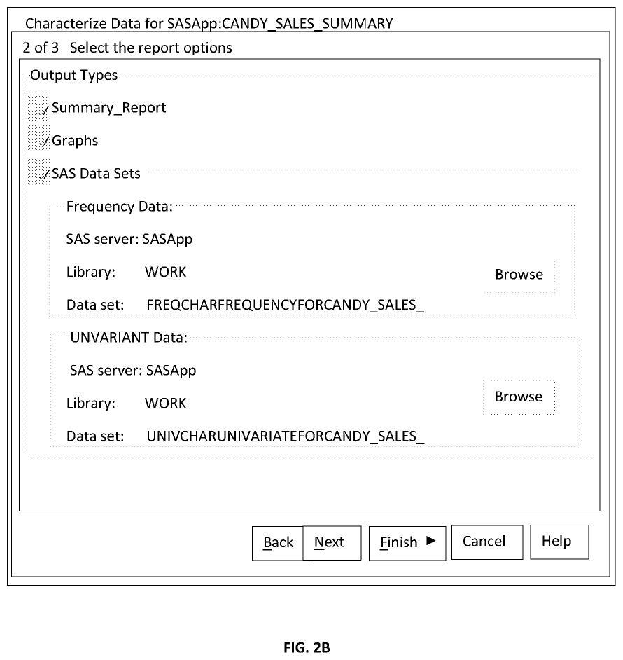

FIG. 3 illustrates an example prioritized summary table output 300 generated by the system, showing top observations for user-selected and automatically discovered variables and their relationship descriptions, along with general frequency observations.

FIG. 4 illustrates an example hidden trends and relationships output 400 generated by the observation generation module of the system, showing pairs of variables from a candy sales dataset, the classified strength of each relationship, and the corresponding technique-specific plain-language observation generated for each pair.

FIG. 5 is a flowchart illustrating a method 500 of automated statistical analysis in user-seeded operating mode, comprising steps 502 through 510 for dataset receipt, seed variable selection, statistical technique selection, correlation execution, and structured output delivery.

FIG. 6 is a flowchart illustrating a method 600 of performing correlation across selected variables in user-seeded mode, comprising steps 602 and 604 for receiving a user input comprising one or more seed variables and performing correlation with ranking of observations in order of relevance.

### DETAILED DESCRIPTION

### Overview

The present technology addresses a fundamental limitation of existing statistical analysis tools: the requirement for human judgment in selecting the appropriate statistical technique for each pair of variables to be analyzed. In practice, this requirement restricts analysis to the pairs a user thinks to examine, using the techniques the user knows to apply—creating a ceiling defined by the user's statistical expertise and the time available for manual analysis.

The present system removes that ceiling entirely. The system implements a three-step analytical pipeline: (1) automatic detection of the variable type of each variable in a dataset; (2) automatic selection of the appropriate statistical technique for each variable pair, based solely on the combination of variable types in that pair, according to a predefined deterministic rule set; and (3) generation of a technique-specific plain-language observation for each variable pair for which a statistically significant relationship is found, using a predefined deterministic template library. Each step is performed by the processor without human intervention. The consuming system—whether a human user, a database, an automated agent, a messaging system, or any other downstream process —receives a complete, prioritized set of plain-language observations describing every statistically meaningful relationship in the dataset, including relationships that the user never explicitly requested.

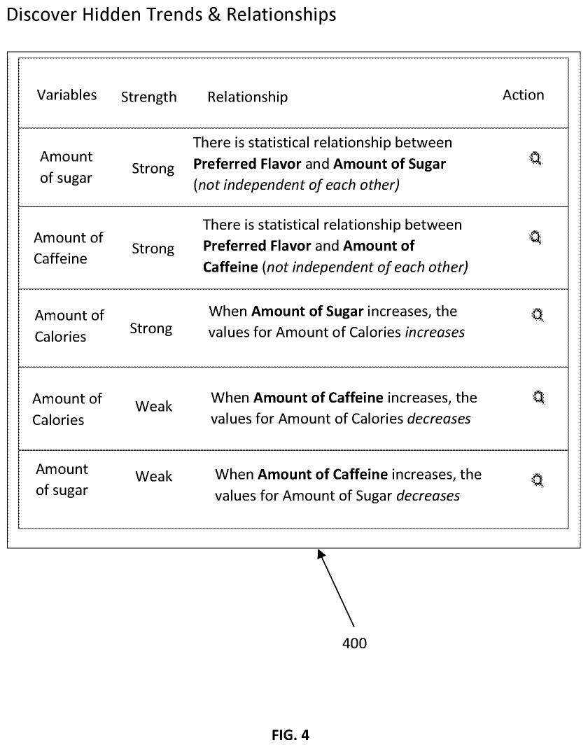

As illustrated in FIG. 4, the output of the observation generation module for a candy sales dataset includes technique-specific plain-language observations for each variable pair where a statistically significant relationship was found—for example, “There is a statistical relationship between Preferred Flavor and Amount of Sugar (not independent of each other),” “When Amount of Sugar increases, the values for Amount of Calories increase,” and “When Amount of Caffeine increases, the values for Amount of Calories decrease.” Each of these observations is generated deterministically from a predefined natural language template corresponding to the statistical technique applied to that variable pair.

### Variable Types

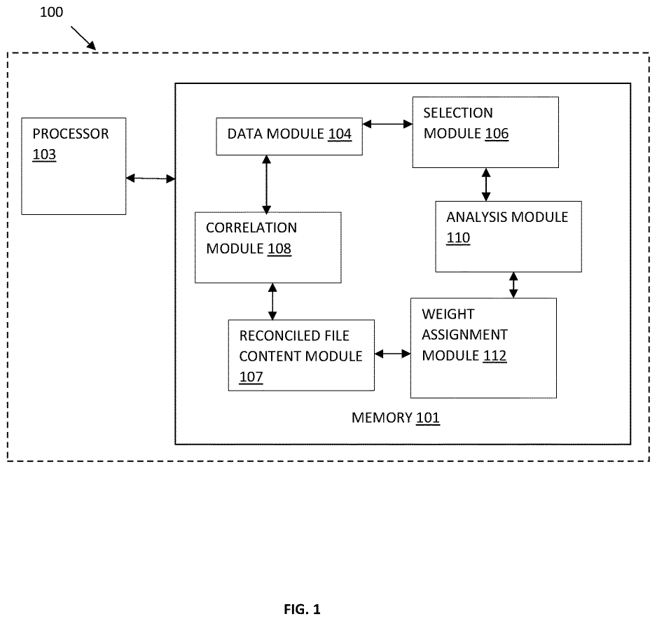

The system supports the following variable types, which together encompass the full range of variable types encountered in real-world datasets. The variable detection module (implemented in the data module 104 of FIG. 1) automatically identifies the type of each variable in a dataset prior to analysis, without user input, by examining the structure and values of each variable according to predefined detection rules.

Continuous numerical variables take values across a measurable range and may include any value within that range, such as temperature, income, or weight.

Discrete numerical variables take countable numerical values, such as the number of purchases or age expressed in whole years.

Nominal categorical variables represent categories with no inherent ordering among them, such as country of origin, product category, or brand preference.

Ordinal categorical variables represent categories with a defined ordering but without uniform intervals between values, such as satisfaction ratings (e.g., “poor/fair/good/excellent”) or education level.

Binary variables are a special case of categorical variable with exactly two possible values, such as yes/no, true/false, or 0/1.

Ranked variables represent values assigned according to their relative position in an ordered sequence, where the intervals between ranks are not assumed to be uniform.

### Rule-based Technique Selection Engine (FIG. 1, Selection Module 106)

The selection module 106 of FIG. 1 implements the rule-based technique selection engine, which is the core of the present invention. For each pair of variables in the dataset, the selection module maps the combination of detected variable types to the appropriate statistical technique, according to a predefined rule set that reflects established statistical practice. This mapping is deterministic: the same combination of variable types always yields the same technique selection. No human input, machine learning model, or generative artificial intelligence system is used in this step.

The predefined deterministic rule set operates as follows, by way of illustration and not limitation:
a. When both variables in a pair are continuous or discrete numerical variables, the engine selects the Pearson product-moment correlation coefficient to measure the linear relationship between them.
b. When both variables are ordinal or ranked, or when one or both variables in the pair cannot be assumed to satisfy the normality assumptions required for Pearson correlation, the engine selects the Spearman rank correlation coefficient.
c. When one variable is numerical (continuous or discrete) and the other is binary, the engine selects an independent samples t-test to assess whether the mean value of the numerical variable differs significantly between the two groups defined by the binary variable.
d. When one variable is numerical and the other is nominal or ordinal categorical with more than two categories, the engine selects a one-way analysis of variance (ANOVA) if the distributional assumptions for that technique are satisfied, or a Kruskal-Wallis test if they are not.
e. When both variables are categorical—in any combination of nominal, ordinal, and binary types—the engine selects the chi-squared test of independence.

The predefined rule set is not limited to the techniques enumerated above. The rule set may include additional techniques appropriate to additional variable type combinations, and the system is extensible to incorporate further techniques as the rule set is updated. The technique selection step requires no human input and employs no machine learning or artificial intelligence; it is a deterministic mapping from variable type combination to technique, codifying the same rules a trained statistician would apply.

### Plain-language Observation Generation (FIG. 4)

The reconciled file content module 107 of FIG. 1 implements the observation generation function. For each variable pair for which the executed statistical technique produces a statistically significant result, the module generates a plain-language observation. This observation is not produced by a language model, generative artificial intelligence system, or any probabilistic text generation method. Instead, the observation is generated by a deterministic two-step process: (1) selecting, from a predefined library of natural language templates, the template corresponding to the statistical technique applied to that pair; and (2) populating that template with the variable names and quantitative result values produced by the execution of that technique.

Each template in the predefined library is authored by subject matter experts to express, in natural language, the precise statistical meaning of the result produced by its corresponding technique. The wording of each template is fixed at authoring time and does not vary based on context, user, session, or any probabilistic process. Because the same template is always selected for the same technique and is always populated with the same inputs, the same variable pair with the same data will always produce the same observation text. This determinism distinguishes the present system from language-model-based approaches, which produce probabilistic and non-reproducible output.

Each plain-language observation encodes three distinct pieces of information: (i) whether a statistically significant relationship exists between the two variables, as determined by the p-value produced by the technique; (ii) the magnitude or strength of that relationship, as measured by the effect size or correlation coefficient produced by the technique; and (iii) the nature of the relationship, expressed in natural language specific to the statistical technique applied. The following examples, as illustrated in FIG. 4, illustrate the technique-specific nature of the observations generated:
a. For a t-test result: “The mean value for Amount of Calories is dependent on whether Prefer Carbonated Beverages is No or Yes.” This wording reflects the t-test's assessment of mean differences across binary groups.
b. For a Spearman rank correlation result: “As the scale for Satisfaction with GoodTea increases, the scale for Willingness to Try New Beverage increases.” This wording reflects the directional relationship between the ranks of the two ordinal variables.
c. For a Pearson product-moment correlation result: “When Amount of Sugar increases, the values for Amount of Calories increase.” This wording, illustrated in FIG. 4, reflects the directional linear relationship between two numerical variables.
d. For a Kruskal-Wallis test result: “The median value for Willingness to Try New Beverage is dependent on whether Prefer Carbonated Beverages is No or Yes.” This wording reflects the Kruskal-Wallis test's assessment of median differences across categorical groups.

The language in each observation is chosen to reflect the mathematical meaning of the technique applied. A t-test result is described in terms of mean dependence on a binary grouping variable. A Spearman result is described in terms of directional scale relationships. A Pearson result is described in terms of directional magnitude change. A Kruskal-Wallis result is described in terms of median dependence on a categorical grouping variable. This technique-specificity ensures that the plain-language observation accurately represents the mathematical result, without overstating, understating, or mischaracterizing the nature of the relationship found, and without requiring a language model to synthesize the wording at runtime.

### Operating Modes

### Autonomous Mode

In the autonomous operating mode, the system 100 operates on a dataset without any user input regarding which variables to analyze or which techniques to apply. The selection module 106 enumerates all possible pairs of variables in the dataset, applies the technique selection rule set to each pair to determine the appropriate statistical technique, and submits each pair and its assigned technique to the correlation module 108 for execution. The reconciled file content module 107 generates a plain-language observation for each pair where a statistically significant relationship is found. The analysis module 110 compiles all plain-language observations into a prioritized list and delivers the structured output to a configured consuming system.

The consuming system may be any system capable of receiving and acting on the output, including but not limited to: a user interface for display to a human user; a database or data store for persistence and subsequent querying; an application programming interface (API) for consumption by another application; a messaging or notification system such as an email application, SMS gateway, or push notification service; or an automated downstream process or agent that uses the output as an input to a subsequent chain of operations, such as triggering alerts, initiating workflows, updating records in a database, or informing decisions made by an artificial intelligence agent. The autonomous mode does not require a human to be the terminal recipient of the output; the system functions as an analytical engine producing structured data for consumption by any downstream system.

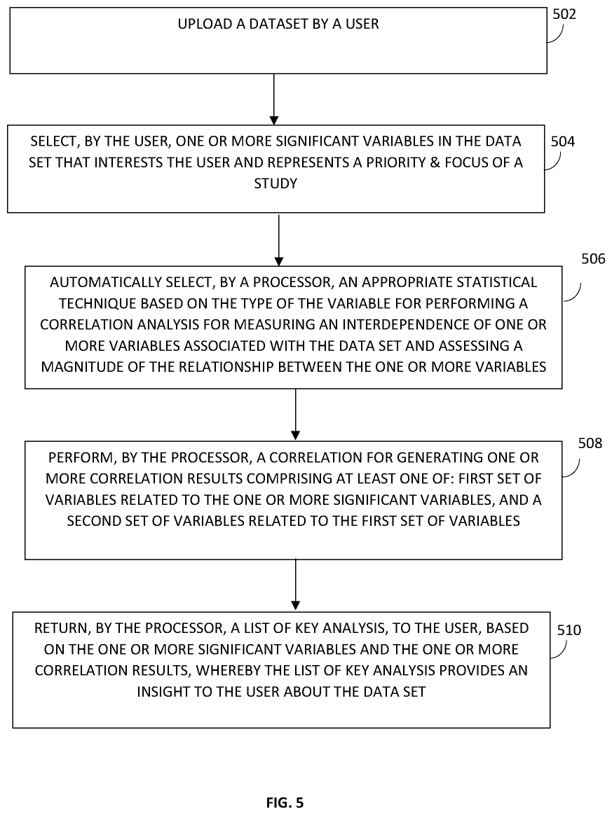

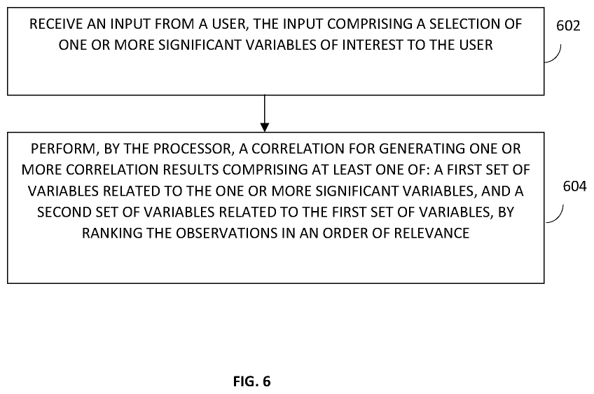

### User-Seeded Mode (FIGS. 5 and 6)

In the user-seeded operating mode, illustrated in FIGS. 5 and 6, the user provides one or more seed variables that represent variables of particular interest. As shown in FIG. 5, at step 502 a dataset is received, and at step 504 the user selects one or more seed variables. The data module 104 receives this selection and passes it to the selection module 106, which at step 506 automatically selects the appropriate statistical technique for each variable pair involving the seed variables, according to the same deterministic rule set used in autonomous mode. At step 508, the correlation module 108 executes the selected techniques. At step 510, the analysis module 110 returns to the user a prioritized list of plain-language observations based on the seed variables and the correlation results.

As further illustrated in FIG. 6, step 604 of the correlation method may optionally include ranking the observations in an order of relevance. Optionally, and without further user intervention, the selection module 106 may automatically expand the variable set by identifying one or more additional variables in the dataset that are statistically related to the seed variables. These additional variables are identified through the same correlation analysis pipeline and are then incorporated into the full analysis before the structured output is delivered. Whether or not the optional variable discovery step is performed, the core three-step analytical pipeline —variable type detection, technique selection, technique execution, and plain-language observation generation —operates identically to the autonomous mode.

### Ranking and Prioritization (Weight Assignment Module 112)

The weight assignment module 112 of FIG. 1 assigns individual weights to observations based on factors including the variable type, whether a variable was selected as a seed variable by the user, the degree of the relationship (whether the variable is a first-degree, second-degree, or third-degree variable relative to a seed variable), and the strength or magnitude of the relationship found. As used herein, a “first-degree variable” refers to a variable selected by the user as a seed variable; a “second-degree variable” refers to a variable that has a relationship with a first-degree variable of very strong or strong magnitude; and a “third-degree variable” refers to a variable that has a relationship with a second-degree variable of very strong magnitude.

The prioritized list of observations delivered to the consuming system is ordered by a relevance score computed for each observation. The relevance score is given by:

Ranking_Score=(Score/Value_Range)×Factor_Weight

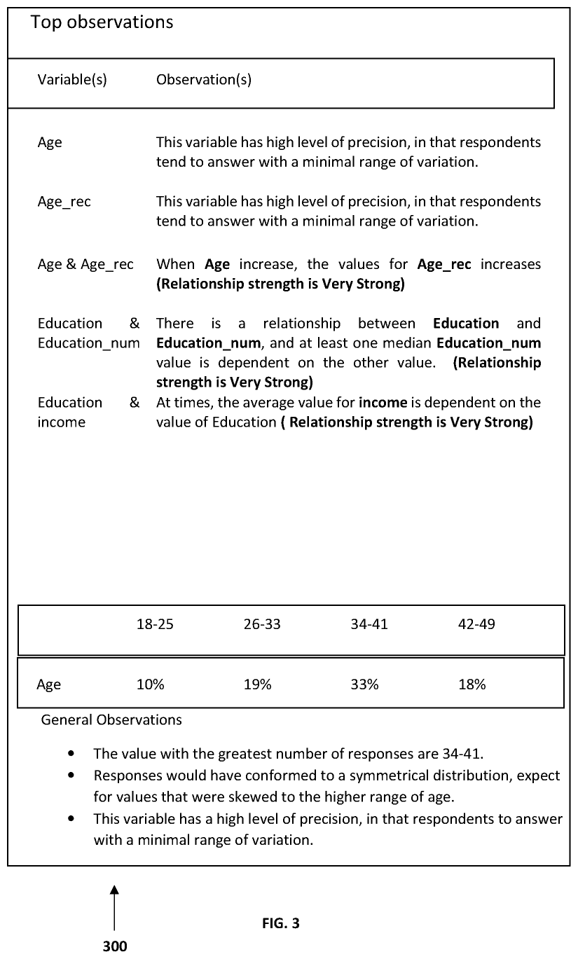

The Ranking_Score is assigned to each observation, and the observations are ordered with the greatest Ranking_Score first, so that the consuming system receives the most analytically significant observations at the top of the output list. Observations involving seed variables selected by the user are weighted more heavily than observations involving automatically discovered variables. Observations reflecting stronger relationships (e.g., very strong correlation) receive higher scores than observations reflecting weaker relationships. As illustrated in FIG. 3, the summary table output 300 shows top observations for selected variables, organized so that the most significant observations appear first.

### System Architecture (FIG. 1)

Referring to FIG. 1, the system 100 comprises a memory 101 storing one or more executable modules and a processor 103 configured to execute those modules. The modules include:
a. Data module 104 (variable detection module): Receives the dataset and, in user-seeded mode, the user's selection of one or more seed variables. Automatically detects the type of each variable in the dataset according to predefined detection rules, without user input.
b. Selection module 106 (technique selection module): For each pair of variables, maps the combination of detected variable types to the appropriate statistical technique according to the predefined deterministic rule set, without human intervention and without machine learning or generative artificial intelligence. In the autonomous mode, enumerates all possible variable pairs. In the user-seeded mode, processes at least all pairs comprising one or more seed variables and, optionally, additional discovered variables.
c. Correlation module 108 (execution module): Executes the selected statistical technique for each variable pair, producing a p-value, effect size or correlation coefficient, and any additional statistical outputs required for observation generation.
d. Reconciled file content module 107 (observation generation module): For each variable pair where a statistically significant relationship is found, selects the corresponding natural language template from the predefined template library and populates it with the variable names and result values to produce a plain-language observation, without the use of a language model or generative artificial intelligence.
e. Analysis module 110 (output module): Compiles all plain-language observations into a prioritized list and delivers the structured output to a consuming system. Configurable to deliver output to any consuming system, including a user interface, a database, an API, a messaging system, or an automated downstream process or agent.
f. Weight assignment module 112: Assigns individual weights to variables, observation types, and analysis results based on factors including variable type, whether the variable was selected by the user, the degree of the variable relative to seed variables, and the magnitude of the relationship found. Computes the Ranking_Score for each observation to determine the ordering of the prioritized output list.

### Advantages Over Prior Art

The present invention differs from the prior art in the following material respects. First, existing tools—including SAS, Q Software Smart Tables, Displayr, EasyMedStat, and STATSOMAT—require the user to select the statistical technique to be applied or to specify the variable pairs to be analyzed, limiting analysis to techniques the user knows and variable pairs the user thinks to examine. The present system selects the technique automatically according to a deterministic rule set, enabling complete many-to-many analysis of all variable pairs regardless of user expertise. Second, existing tools that perform automated technique selection do so for a single user-specified analysis at a time; no existing tool enumerates all variable pairs simultaneously and analyzes them in a single automated pass. Third, existing tools that generate plain-language output either rely on language models or generative artificial intelligence, which produce probabilistic and non-reproducible text, or generate only generic statistical significance statements. The present system generates technique-specific natural language observations from a predefined deterministic template library, producing fully reproducible output that accurately reflects the mathematical meaning of each technique. Fourth, existing tools are designed to deliver output to a human user as the terminal recipient; the present system is designed to deliver structured output to any consuming system, enabling its use as an analytical engine within automated pipelines and agentic workflows.

### Definitions and Standard Provisions

A “non-transitory computer-readable medium” as used herein may be any medium that can contain, store, communicate, propagate, or transport the program for use by or in connection with the instruction execution system, apparatus, system, or device. The computer-readable medium may be, by way of example only and not limitation, an electronic, magnetic, optical, electromagnetic, infrared, or semiconductor system, apparatus, system, device, propagation medium, or computer memory.

A “processor” as used herein includes any human, hardware and/or software system, mechanism or component that processes data, signals, or other information. A processor may include a system with a general-purpose central processing unit, multiple processing units, dedicated circuitry for achieving functionality, or other systems. Processing need not be limited to a geographic location or have temporal limitations.

The embodiments herein can take the form of an entirely hardware embodiment, an entirely software embodiment, or an embodiment including both hardware and software elements. Embodiments implemented in software include but are not limited to firmware, resident software, and microcode. The embodiments herein can take the form of a computer program product accessible from a computer-usable or computer-readable medium providing program code for use by or in connection with a computer or any instruction execution system.

As will be readily apparent to those skilled in the art, the present invention may easily be produced in other specific forms without departing from its essential characteristics. The present embodiments are therefore to be considered as illustrative and not restrictive, the scope of the invention being indicated by the claims rather than the foregoing description, and all changes which come within the meaning and range of equivalents of the claims are therefore intended to be embraced therein.

1. A processor-implemented method of automated statistical analysis of a dataset, the method comprising:
receiving, by a processor, a dataset comprising a plurality of variables;
automatically detecting, by the processor, a variable type for each variable in the plurality of variables, wherein the variable types include at least two of: continuous numerical, discrete numerical, nominal categorical, ordinal categorical, binary, and ranked;
automatically selecting, by the processor and without human intervention in the selection step, a statistical technique for each pair of variables in the plurality of variables, wherein the selection is performed by mapping the combination of variable types of each pair to a corresponding statistical technique according to a predefined deterministic rule set, and wherein no machine learning model or generative artificial intelligence system is used in the selection step;
executing, by the processor, the selected statistical technique for each pair of variables to produce a result comprising at least a measure of statistical significance and a measure of relationship magnitude;
generating, by the processor, for each pair of variables for which a statistically significant relationship is found, a plain-language observation by: (a) selecting, from a predefined library of natural language templates, the template corresponding to the statistical technique applied to that pair; and (b) populating the selected template with variable names and result values from the execution of that technique; wherein the plain-language observation is generated without the use of a language model or generative artificial intelligence system, and wherein the plain-language observation encodes: (i) whether a statistically significant relationship exists between the variables of the pair, (ii) the magnitude or strength of that relationship, and (iii) a natural language description of the nature of the relationship expressed in terminology corresponding to the statistical technique applied; and
delivering a structured output comprising a prioritized list of the plain-language observations to at least one consuming system.

2. The method of claim 1, wherein the at least one consuming system comprises at least one of: a user interface for display to a human user; a database or data store; an application programming interface; a messaging or notification system; or an automated downstream process or agent that uses the structured output as an input to a subsequent chain of operations.

3. The method of claim 1, wherein the dataset is received and analyzed without any user input regarding which variables to analyze or which statistical techniques to apply, and wherein all variable pairs in the dataset are automatically enumerated and analyzed by the processor without user specification of the variable pairs to analyze.

4. The method of claim 1, wherein the predefined deterministic rule set maps:
a pair of continuous or discrete numerical variables to a Pearson product-moment correlation coefficient;
a pair of ordinal or ranked variables, or a pair of variables not satisfying distributional assumptions required for Pearson correlation, to a Spearman rank correlation coefficient;
a pair comprising one numerical variable and one binary variable to an independent samples t-test;
a pair comprising one numerical variable and one nominal or ordinal categorical variable having more than two categories to a one-way analysis of variance or a Kruskal-Wallis test selected based on distributional properties of the data; and
a pair of categorical variables, in any combination of nominal, ordinal, and binary types, to a chi-squared test of independence.

5. The method of claim 1, wherein the plain-language observation generated for an independent samples t-test result describes the dependence of a mean value of a first variable on the categories of a second binary variable.

6. The method of claim 1, wherein the plain-language observation generated for a Spearman rank correlation result describes a directional relationship between scale values of the two variables.

7. The method of claim 1, wherein the plain-language observation generated for a Pearson product-moment correlation result describes the directional change in one variable as the other variable increases.

8. The method of claim 1, wherein the plain-language observation generated for a Kruskal-Wallis test result describes the dependence of a median value of a first variable on the categories of a second categorical variable.

9. The method of claim 1, wherein the predefined library of natural language templates comprises a distinct pre-authored template for each statistical technique in the predefined deterministic rule set, and wherein the wording of each template is fixed and does not vary based on context, user, session, or any probabilistic process, such that the same variable pair analyzed with the same data always produces the same plain-language observation text.

10. The method of claim 1, further comprising:
receiving, from a user, a selection of one or more seed variables from the plurality of variables; and
performing the automatic selection, execution, and plain-language observation generation steps across at least all pairs of variables comprising one or more of the seed variables.

11. The method of claim 10, further comprising:
automatically identifying, by the processor and without further user intervention, one or more additional variables in the dataset that are statistically related to the one or more seed variables; and
performing the automatic selection, execution, and plain-language observation generation steps across pairs comprising at least one of the one or more seed variables and at least one of the one or more additional variables.

12. The method of claim 10, wherein the prioritized list of plain-language observations is ordered by a relevance score computed for each observation, wherein the relevance score accounts for at least the magnitude of the relationship found and whether the variables in the pair include one or more of the user-provided seed variables.

13. The method of claim 2, wherein the at least one consuming system is an automated downstream process or agent, and wherein the structured output is used by the automated downstream process or agent as an input to at least one of: triggering an alert or notification; initiating a workflow; updating a record in a database; or informing a decision made by an artificial intelligence agent.

14. A system for automated statistical analysis of a dataset, the system comprising:
a memory storing one or more executable modules; and
a processor configured to execute the one or more executable modules, the modules comprising:
a variable detection module configured to automatically detect a variable type for each variable in a plurality of variables in a dataset, wherein the variable types include at least two of: continuous numerical, discrete numerical, nominal categorical, ordinal categorical, binary, and ranked;
a technique selection module configured to automatically select, without human intervention in the selection step and without the use of a machine learning model or generative artificial intelligence system, a statistical technique for each pair of variables in the plurality of variables by mapping the combination of variable types of each pair to a corresponding statistical technique according to a predefined deterministic rule set;
an execution module configured to execute the selected statistical technique for each pair of variables to produce a result comprising at least a measure of statistical significance and a measure of relationship magnitude;
an observation generation module configured to generate, for each pair of variables for which a statistically significant relationship is found, a plain-language observation by selecting a natural language template from a predefined template library corresponding to the statistical technique applied and populating that template with variable names and result values, without the use of a language model or generative artificial intelligence system, wherein the plain-language observation encodes: (i) whether a statistically significant relationship exists, (ii) the magnitude or strength of that relationship, and (iii) a natural language description of the nature of the relationship in terminology corresponding to the statistical technique applied; and
an output module configured to deliver a structured output comprising a prioritized list of the plain-language observations to at least one consuming system comprising at least one of: a user interface, a database, an application programming interface, a messaging or notification system, or an automated downstream process or agent.

15. The system of claim 14, wherein the technique selection module maps:
a pair of continuous or discrete numerical variables to a Pearson product-moment correlation coefficient;
a pair of ordinal or ranked variables to a Spearman rank correlation coefficient;
a pair comprising one numerical variable and one binary variable to an independent samples t-test;
a pair comprising one numerical variable and one nominal or ordinal categorical variable having more than two categories to a one-way analysis of variance or a Kruskal-Wallis test; and
a pair of categorical variables, in any combination of nominal, ordinal, and binary types, to a chi-squared test of independence.

16. The system of claim 14, wherein the variable detection module is configured to receive a dataset and the technique selection module is configured to enumerate all possible variable pairs in the dataset without user specification of which pairs to analyze, and wherein the technique selection module, execution module, and observation generation module process all enumerated variable pairs without user input.

17. The system of claim 14, wherein the variable detection module is further configured to receive from a user a selection of one or more seed variables, wherein the technique selection module is further configured to optionally and automatically identify one or more additional variables in the dataset that are statistically related to the seed variables without further user intervention, and wherein the execution module performs analysis across pairs comprising the seed variables and the optionally identified additional variables.

18. The system of claim 14, wherein the predefined template library comprises a distinct pre-authored natural language template for each statistical technique in the predefined deterministic rule set, and wherein the wording of each template is fixed such that the same variable pair analyzed with the same data always produces the same plain-language observation text.

19. A non-transitory computer-readable medium storing instructions that, when executed by a processor, cause the processor to perform steps comprising:
receiving a dataset comprising a plurality of variables, each having a variable type;
automatically detecting the variable type of each variable without user input, wherein the variable types include at least two of: continuous numerical, discrete numerical, nominal categorical, ordinal categorical, binary, and ranked;
automatically selecting, without human intervention and without the use of a machine learning model or generative artificial intelligence system, a statistical technique for each pair of variables by applying a predefined deterministic rule set that maps combinations of variable types to corresponding statistical techniques;
executing the selected statistical technique for each variable pair to produce at least a measure of statistical significance and a measure of relationship magnitude;
generating, for each variable pair for which a statistically significant relationship is found, a plain-language observation by selecting a natural language template from a predefined template library corresponding to the statistical technique applied and populating that template with variable names and result values, without the use of a language model or generative artificial intelligence system, wherein the plain-language observation encodes: (i) whether the relationship is statistically significant, (ii) the magnitude of the relationship, and (iii) a natural language description of the nature of the relationship in terminology specific to the statistical technique applied; and
delivering a structured output comprising a prioritized list of the plain-language observations to at least one consuming system.

20. The computer-readable medium of claim 19, wherein the instructions further cause the processor to receive a user selection of one or more seed variables and to perform the detecting, selecting, executing, and generating steps across at least all variable pairs comprising one or more of the seed variables, and optionally to automatically identify, without further user intervention, one or more additional variables in the dataset that are statistically related to the seed variables, and to perform the detecting, selecting, executing, and generating steps across pairs comprising the seed variables and the additional variables.
